(19) United States
(12) Patent Application Publication
(10) Pub. No.: US 2007/0165406 A1
(43) Pub. Date: Jul. 19, 2007

(54) Display with an illuminating light

(75) Inventor: Mingjun Wang, Shenzhen (CN)

Correspondence Address: LERNER GREENBERG STEMER LLP, P O BOX 2480, HOLLYWOOD, FL, 33022-2480, US

(73) Assignee: Proview Technology (Shenzhen) Co., Ltd.

(21) Appl. No.: 11/653,572

(22) Filed: Jan. 16, 2007

(30) Foreign Application Priority Data
Jan. 14, 2006 (CN) 200620005121.6

(51) Int. Cl. F21V 33/00

(52) U.S. Cl. 362/253

(57) ABSTRACT

A display has a housing with an illuminating light on the front frame of the housing. A control unit switches the operating mode of the illuminating light. The illuminating light is capable of emitting light for illuminating a specific area near the display, so that the user can operate a keyboard or read a document in a dark environment.

### CROSS-REFERENCE TO RELATED APPLICATION

The present invention claims the priority of Chinese patent application number 200620005121.6 filed on Jan. 14, 2006, which is incorporated by reference in its entirety.

### BACKGROUND OF THE INVENTION

### Field of the Invention

The present invention relates to a display, in particular, to a computer display or display monitor.

Prior art computer displays comprise a housing, a display control circuit, a control unit and a display unit. Typically, there are provided a plurality of function buttons on the front face of the housing, one or more of which may include an LED. For example, button POWER may have an LED. In most cases, the LED is used as an indicator lamp, which is green in normal state and red otherwise. The brightness of the LED is too finite to allow it to function as an illuminating light. In a dark environment, however, light is sometimes needed to illuminate the keyboard, a file and so on, so that operations may be made easy. However, the light source of a display itself is not sufficient to meet such requirements.

### SUMMARY OF THE INVENTION

It is accordingly an object of the invention to provide a display which overcomes the above-mentioned disadvantages of the heretofore-known devices and methods of this general type and which is provided with an illuminating light and a corresponding controller that satisfy the above-noted objects with regard to the illumination requirements.

With the foregoing and other objects in view there is provided, in accordance with the invention, a display, comprising:

a housing having a frame;

an illuminating light disposed on said frame of said housing; and

a control unit for controlling an operating mode of said illuminating light.

In other words, the objects of the invention are achieved in that there is provided a display comprising a housing, wherein the display further comprises an illuminating light on front frame of the housing of the display and a control unit for controlling the operating mode of the illuminating light.

Preferably, the illuminating light comprises one or a plurality of LEDs (light-emitting diodes) each of which includes a first terminal and a second terminal, a pull-up resistor, and a controllable switching component. Each LED is coupled, with its first terminal, to ground and coupled, with its second terminal, to a node between the pull-up resistor (which is coupled to a power supply) and the controllable switching component (which is coupled to ground). The controllable switching component is switched on or off under the control of the control unit.

In accordance with an added feature of the invention, the second terminal of each LED is connected through a respective current limiting resistor (R1, R3, R5) to the afore-mentioned node.

Preferably, at least one of the one or a plurality of LEDs is coupled, with the second terminal, to the control unit through a respective regulating resistor.

Preferably, said plurality of LEDs comprises three LEDs showing at least one of red, green and blue color.

Preferably, said controllable switching component is selected from the group consisting of switching transistor and field effect transistor.

Preferably, said display is selected from the group consisting of CRT display and flat-panel display.

Preferably, said illuminating light further comprises a light guiding means for guiding the light emitted to a specific area.

Preferably, said illuminating light is capable of operating in one of normal operating mode, energy saving mode, and high lighting mode, wherein:

when the illuminating light is in the normal operating mode, the display works in a normal state, in which one of the LEDs is lit up, the illuminating light is used as an indicator lamp and emits monochrome;

when the illuminating light is in the energy saving mode, the display is in energy saving sate, in which two of the three LED lamps are lit up under the control of the control unit, the illuminating light is used as an indicator lamp and emits mixed color; and

when the illuminating light is in the high lighting mode, all of the three LED lamps are lit up simultaneously under the control of the control unit; the illuminating light is used for illumination.

Preferably, the illuminating light is capable of entering/escaping from the High lighting mode by switching on/off the switch.

Preferably, the illuminating light is switched to High lighting State by a keyboard or a mouse both of which are connected with a PC.

Preferably, the illuminating light is capable of escaping from the High lighting mode after a predetermined time under the control of the control unit.

The display with an illuminating light according to the invention may illuminate a certain region in a dark environment and may meet the requirements of keyboard illumination and reading, etc.

Other features which are considered as characteristic for the invention are set forth in the appended claims.

Although the invention is illustrated and described herein as embodied in a display with an illuminating light, it is nevertheless not intended to be limited to the details shown, since various modifications and structural changes may be made therein without departing from the spirit of the invention and within the scope and range of equivalents of the claims.

The construction of the invention, however, together with additional objects and advantages thereof will be best understood from the following description of the specific embodiment when read in connection with the accompanying drawings.

### BRIEF DESCRIPTION OF THE DRAWINGS

FIG. 1 is a front view of a display with an illuminating light according to an embodiment of the invention;

FIG. 2 is a circuit module diagram of a display with an illuminating light according to an embodiment of the invention; and

FIGS. 3A, 3B, 3C, 3D, and 3E (summarily referred to as FIG. 3) show five circuit diagrams of illuminating light of a display with an illuminating light according to the invention.

### DETAILED DESCRIPTION OF AN EXEMPLARY EMBODIMENT

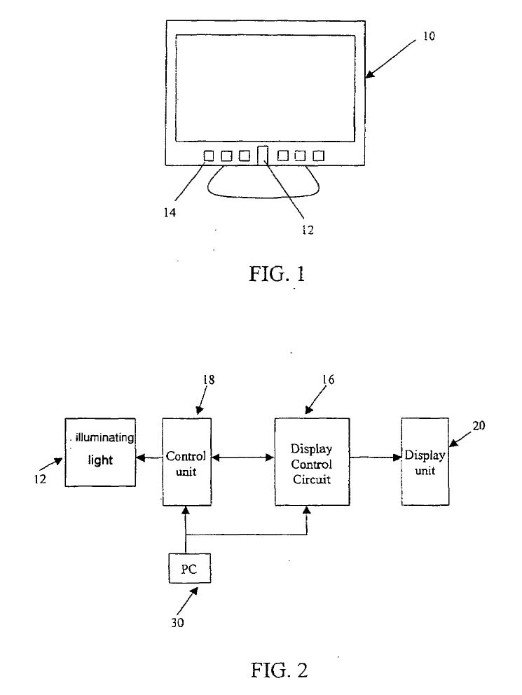

Referring now to the figures of the drawing in detail and first, particularly to FIG. 1 thereof, there is shown a front view of a display with an illuminating light according to an embodiment of the invention. The display 10 may be, for example, a CRT display or a flat panel display. An illuminating light 12, for example an LED or an LED array, and a switch 14 for turning on/off the illuminating light 12 are arranged on a front frame of the housing of the display 10. The LED may illuminate a certain region in front of the front frame, such as a keyboard, etc., so that the user can operate the keyboard or read a document in an otherwise dark environment.

As shown in FIG. 2, the display 10 comprises an illuminating light 12, a display control circuit 16, a control unit 18 and a display unit 20. The display control circuit 16 and the control unit 18 are in two-way communication with each other and are electrically connected with a PC 30; the display control circuit 16 receives image signals from the PC 30 and control signals from the control unit 18, and outputs signals to the display unit 20 after processing; and the control unit 18 may receive control signals from the PC 30 or the switch 14 to control the illuminating light 12.

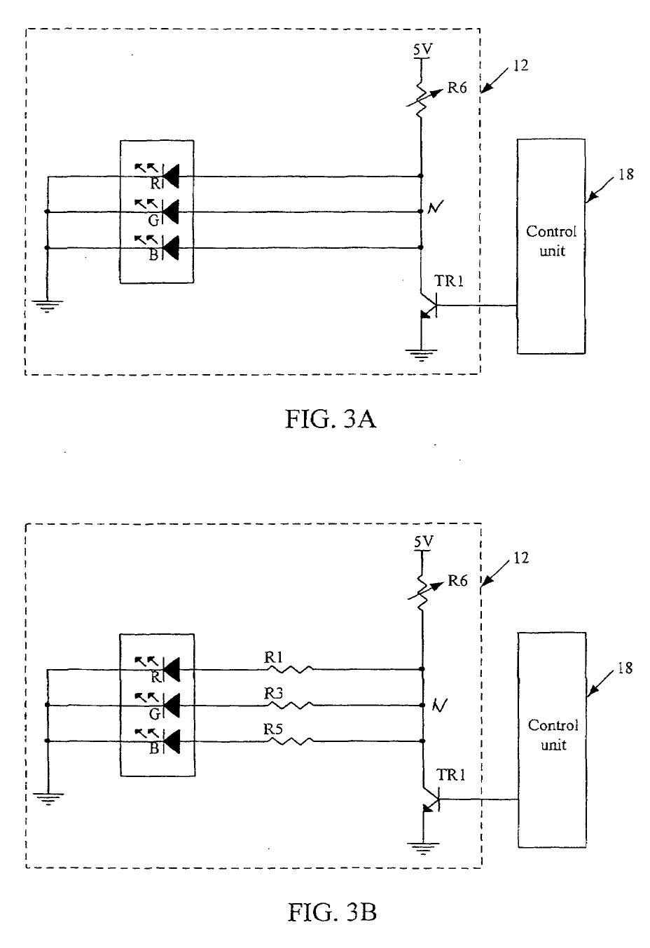

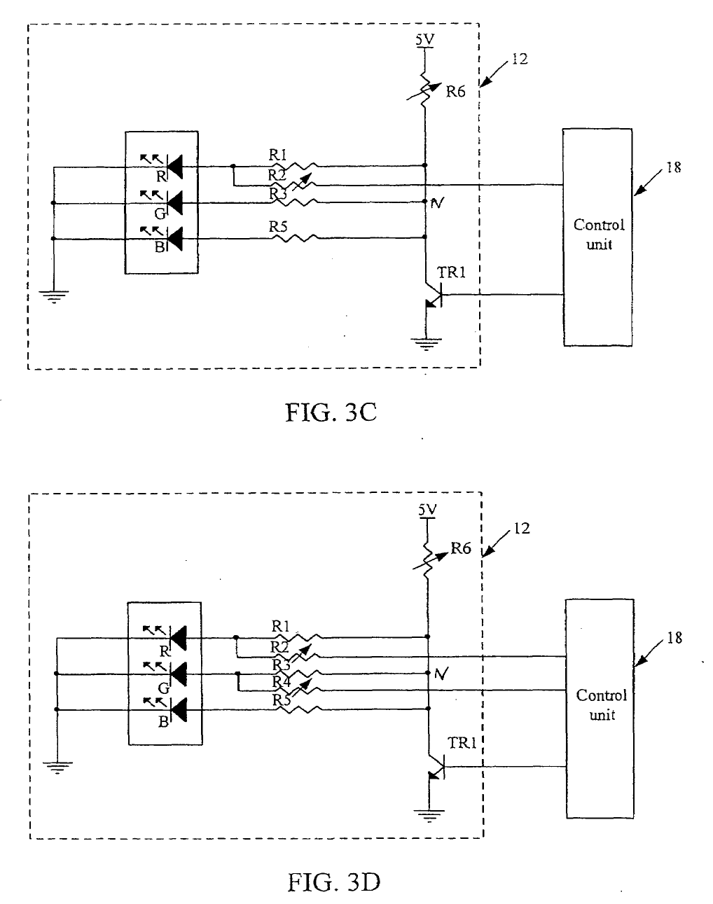

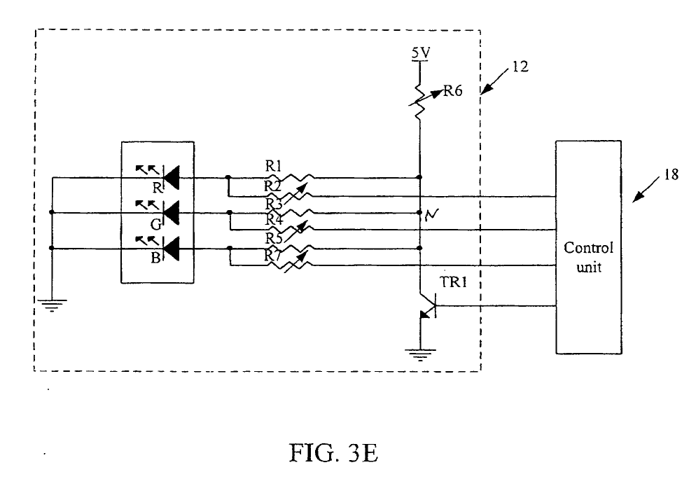

FIG. 3, including FIG. 3A, FIG. 3B, FIG. 3C, FIG. 3D and FIG. 3E, shows five circuit diagrams for controlling the illuminating light 12 according to various embodiments of the invention.

As shown in FIG. 3A, according to an embodiment of the circuit, the illuminating light 12 comprises three LEDs, namely, LED-R (red), LED-G (green) and LED-B (blue), a pull-up resistor R6 and a controllable switching component TR1. The controllable switching component TR1 may be a switching transistor or a field effect transistor. Each of the above parts and the control unit 18 and the connections therebetween are shown as in FIG. 3A, wherein, the illuminating light 12 may appear with different brightness or intensity by adjusting the resistance of resistor R6. The illuminating light 12 may be turned on or turned off by the controllable switching component TR1 under the control of the control unit 18.

As shown in FIG. 3B, the illuminating light 12 may further comprise three current limiting resistors R1, R3 and R5 which are connected in series with the LED R (red), G (green) and B (blue) respectively.

Referring to FIG. 3C, FIG. 3D and FIG. 3E, based on the circuit and its function shown in FIG. 3B, the illuminating light 12 may further comprise one to three regulating or control resistors R2, R4 and R7, which are connected in parallel with the current limiting resistors R1, R3 and R5, respectively, and are electrically connected to the control unit 16. When the controllable switching component is in an off state, the regulating resistors R2, R4 and/or R7 may regulate the brightness of at least one of the three LED R (red), LED G (green) and LED B (blue) under the control of the control unit 18. Or, when the controllable switching component TR is in an on state, one or more of the LED R (red), LED G (green) and LED B (blue) may also be directly turned on or turned off by the control unit 18, so that the color of the illuminating light 12 may be changed. At this point, the illuminating light 12 may also be used as an indicator.

With the configuration described above, the illuminating light 12 may have the following modes:
(a) Normal Operating Mode: when the display is in normal operation, one of the LEDs is lit up under the control of the control unit 18. Here, the illuminating light is used as an indicator and appears monochrome (red, green or blue);
(b) Energy Saving Mode: when the display is in Energy Saving State, two of the three LEDs are lit up under the control of the control unit 18, and at this point, the illuminating light is used as an indicator and appears mixed color (e.g., orange);
(c) High Lighting Mode: when all of the three LEDs are lit up simultaneously under the control of the control unit 18, the illuminating light enters High Lighting Mode, and the illumination time may be controlled by the control unit 18, and then the illuminating light 12 returns to Normal Operating Mode.

Alternatively, the High Lighting Mode of the illuminating light 12 may be switched on and switched off under the control of the switch 14 via the control unit 18. In this case, if the switch 14 is switched on, the illuminating light 12 enters the high lighting mode; if the switch 14 is switched off, the illuminating light 12 escapes from the high lighting mode to the normal operating mode. In an embodiment, the illuminating light 12 exits from the high lighting mode to the Energy Saving Mode, depending on the current operating state of the PC. When the PC 30 is in normal operating state, for example, the High Lighting Mode of the illuminating light 12 may be activated by pressing any key on a keyboard or by moving a mouse, both of which are connected with the PC 30. In an embodiment, the illuminating light 12 may return to the Normal Operating Mode under the control of the control unit 18 when a predetermined time period expires; in another embodiment, the illuminating light 12 may return to the Energy Saving Mode under the control of the control unit 18 after a predetermined time period during which no operation is made (for example, via keyboard, or mouse) by the user; Of course, the illuminating light 12 may escape from the High Lighting Mode by simply switching off the switch 14.

It will be appreciated by those of skill in the pertinent art that the illuminating light 12 may comprise one LED, or two LEDs, or more than three LEDs, to realize one or more object of the invention, and the colors of the LEDs are not limited to red, green or blue.

In an embodiment, the illuminating light 12 may further comprise a light guiding means (e.g. a light conductor or light guide) for guiding the light emitted to a specific area, for example, keyboard, or the area nearby, so that only the specific area is illuminated, preventing the light from directly shining into the eyes of the computer user. In one embodiment of the invention, the light guiding means is simply a lamp shade.

In the embodiment shown in FIG. 1, the illuminating light 12 is arranged at the lower portion of the front frame of the housing; it will be understood by those of skill in the art, however, that the illuminating light 12, i.e., the light exit or illumination surface, may be arranged at any suitable position on the front frame of the housing, for example, at the upper portion of the front frame of the housing.

While the present invention has been described with respect to the specific embodiments, it will be apparent to those skilled in the art that various changes and modifications may be made without departing from the spirit and scope of the invention as defined in the following claims.

I claim:

1. A display, comprising:
a housing having a frame;
an illuminating light disposed on said frame of said housing; and
a control unit for controlling an operating mode of said illuminating light.

2. The display according to claim 1, wherein said illuminating light comprises:
one or a plurality of LEDs each having a first terminal connected to ground and a second terminal;
a pull-up resistor connected to a power supply, a controllable switching component connected to ground, and a node between said pull-up resistor and said switching component; and
wherein said second terminal of each of said one or plurality of LEDs is connected to said node between said pull-up resistor and said switching component, and wherein said switching component connected to and selectively switched on or off under control of said control unit.

3. The display according to claim 2, which further comprises one or a plurality of current limiting resistors connected between each said second terminal of said LED and said node.

4. The display according to claim 3, which further comprises at least one control resistor connected between said control unit and a respective said second terminal of said one or plurality of LEDs.

5. The display according to claim 2, wherein said plurality of LEDs include three LEDs showing at least one of the colors red, green and blue.

6. The display according to claim 2, wherein said controllable switching component is a switching transistor or field effect transistor.

7. The display according to claim 1, wherein the display is a CRT display or flat-panel display.

8. The display according to claim 1, wherein said illuminating light further comprises a light guiding means for guiding the light emitted by said one or more LEDs to a specific area.

9. The display according to claim 4, wherein said illuminating light is configured to operating in any of at least three operating modes, including a normal operating mode, an energy saving mode, and a high lighting mode, and wherein:
in the normal operating mode of said illuminating light, the display operates in normal state in which one of said LEDs is lit, said illuminating light is suitable as an indicator lamp and emits substantially monochrome light;
in the energy saving mode of said illuminating light, the display operates in an energy saving state in which two of three LEDs are lit under the control of said control unit, said illuminating light is suitable as an indicator lamp and emits mixed color light; and
in the high lighting mode of said illuminating light, all three LED lamps are lit simultaneously under the control of the control unit, and said illuminating light is suitable for illumination.

10. The display according to claim 9, which further comprises a switch connected to said control unit and configured to enable said control unit to selectively place said illuminating light in high lighting mode.

11. The display according to claim 9, wherein said illuminating light is configured to be switched to high lighting mode through a keyboard or a mouse connected to a PC.

12. The display according to claim 11, wherein said illuminating light is configured to exit from the high lighting mode after a predetermined time under control of said control unit.
